(19) United States
(12) Patent Application Publication
(10) Pub. No.: US 2026/0188150 A1
(43) Pub. Date: Jul. 2, 2026

(54) ILLUMINATION AND RESPONSIVE DISPLAY WINDOW SYSTEM

(71) Applicant: Robert Sipos, Santa Ana (IS)

(72) Inventor: Robert Sipos, Santa Ana (IS)

(21) Appl. No.: 19/439,026

(22) Filed: Jan. 2, 2026

Related U.S. Application Data
(60) Provisional application No. 63/741,242, filed on Jan. 2, 2025.

(51) Int. Cl. G09G 3/00; B32B 17/10; B60J 3/04; B60Q 3/208; G06F 3/04847

(52) U.S. Cl. CPC G09G 3/001; B32B 17/10; B60J 3/04; B60Q 3/208; B32B 2250/02; B32B 2605/006; G06F 3/04847; G09G 2354/00; G09G 2370/16; G09G 2380/10

(57) ABSTRACT

A smart illumination and display system for vehicular windows is disclosed. The system includes a multi-layer smart glass assembly having a polycarbonate outer layer, an electroplated conductive layer, an interior structural substrate, and a capacitive touch-sensing mesh. A processor module controls illumination, tint modulation, wireless communication, and artificial-intelligence-based functions. Fiber optic illumination strands embedded within the glass assembly generate colors, gradients, patterns, images, and dynamic graphical displays. A wireless communication module receives commands from a remote device, while a safety control subsystem monitors vehicle conditions to autonomously restrict or change illumination during motion or low-visibility environments. The system supports touch-based interaction and remote control, enabling real-time adjustment of tint, transparency, and graphical output.

### CROSS-REFERENCE TO RELATED APPLICATION

The present application claims priority to, and the benefit of, U.S. Provisional Application No. 63/741,242 which was filed on Jan. 2, 2025 and is incorporated herein by reference in its entirety.

### FIELD OF THE INVENTION

The present invention generally relates to vehicular, for example, window systems. More specifically, the present invention relates to a smart illumination and display system integrated into a multi-layer glass assembly that enables a user to selectively modify the tint level, color output, illumination pattern, or graphical content of a vehicle window without replacing the window itself or impairing driver visibility. The invention comprises a multi-component assembly that includes a laminated smart glass structure having a polycarbonate outer layer, an electroplated conductive layer, an interior structural substrate, and a multilayer capacitive mesh configured to detect touch input across the window surface. Embedded fiber optic illumination strands are controlled by a processor module positioned within or adjacent to the window frame. A wireless communication module enables the system to receive commands from a remote device, such as a smartphone application, enabling the user to remotely select colors, patterns, or display messages that are rendered on the smart glass assembly. In certain embodiments, the processor module further communicates with an artificial-intelligence engine configured to analyze environmental (i.e., ambient) conditions or historical user interactions and automatically (i.e., autonomously) adjust illumination characteristics accordingly. Accordingly, the present disclosure makes specific reference thereto. Nonetheless, it is to be appreciated that aspects of the present invention are also equally applicable to other like applications, devices, and methods of manufacture.

### BACKGROUND

By way of background, motorists often enjoy personalizing or enhancing the aesthetic appearance of their vehicles. Conventional customization options typically include exterior paint, lighting accessories, or interior accent features. However, vehicle windows remain largely uncustomizable. Automotive windows are generally manufactured as transparent or uniformly tinted surfaces, and any attempt to modify their appearance such as applying decals, films, or non-standard coatings may impair visibility, violate safety regulations, or otherwise compromise driver awareness.

Existing window tinting methods offer limited static adjustments and do not provide dynamic or user-controlled visual effects. Additionally, traditional vehicular window systems lack the ability to integrate advanced smart technology, interactive displays, or touch-responsive features. As consumer interest in smart devices and connected automotive technologies continues to grow, there remains a need for a window system that permits controlled customization without sacrificing safety, visibility, or regulatory compliance

Therefore, there exists a long-felt need in the art for an improved vehicular window system that overcomes the limitations of traditional transparent or tinted windows. There is a long-felt need in the art for a window system that enables users to customize the visual appearance of their vehicle without compromising visibility or violating safety regulations. Additionally, there exists a need for a window system that enables drivers and passengers to selectively modify tint levels, colors, or design elements in real time, rather than relying on static tint films or aftermarket modifications. Moreover, there is a need for a system that transforms a conventional window into an interactive surface capable of displaying patterns, images, messages, or illumination effects while still maintaining road-safe transparency. Finally, there exists a need for a technology that integrates advanced smart functionality including wireless connectivity, touch responsiveness, and intelligent control directly into the structure of the vehicle window itself.

The subject matter disclosed and claimed herein, in one embodiment, comprises a smart illumination and display system configured for installation within or integration into the windows of a residential or commercial vehicle. The system includes a multi-layer electroplated glass assembly comprising a polycarbonate outer layer, an electroplated conductive layer, an interior structural substrate, and a multilayer capacitive mesh for detecting touch input. A processor module is operatively connected to the glass assembly and is configured to execute illumination control routines, process touch signals, manage wireless communication, and operate artificial-intelligence-based algorithms. A plurality of fiber optic illumination strands are embedded within or adjacent to the layers of the glass assembly and are driven by illumination components under the control of the processor module. A wireless communication module enables the system to receive commands from a smartphone or other remote device, enabling users to selectively alter tint opacity, color output, or graphical display content. The system may be mounted within the window frame or integrated directly into a laminated vehicular window structure.

In one embodiment, the processor module is further in communication with an artificial-intelligence (AI) engine configured to analyze gesture input history, ambient light levels, vehicular motion data, and user-defined preferences. The AI engine may automatically (i.e., autonomously) adjust illumination intensity, color transitions, display patterns, or tint opacity in real time based on environmental (i.e., ambient) conditions or predictive behavioral algorithms. The system may additionally include a safety control subsystem comprising sensors for detecting vehicle speed, ambient lighting conditions, and movement, enabling automatic restriction or suppression of illuminated graphics or animated displays during unsafe or regulated operating conditions.

In this manner, the smart illumination and display system of the present invention overcomes longstanding deficiencies in the art by transforming a passive automotive window into an interactive, programmable, and highly customizable visual interface. The invention provides enhanced personalization, improved safety compliance, and increased functional versatility by enabling users to control window tinting, illumination effects, and graphical displays through touch gestures or wireless remote commands. The system offers technological advancement, aesthetic flexibility, and user-driven control without requiring physical modifications or replacement of standard windows.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a smart illumination and display system configured for installation within a vehicular window. The system includes a multi-layer electroplated glass assembly having a polycarbonate outer layer, an electroplated conductive layer, an interior structural substrate, and a multilayer capacitive mesh integrated into at least one of the layers for detecting touch input. A processor module controls illumination functions, processes touch signals, performs wireless communication operations, and executes artificial-intelligence-based routines. A plurality of fiber optic illumination strands are embedded within the glass assembly and driven by illumination drivers controlled by the processor. The system further includes a wireless communication module for receiving user commands from a remote device and a safety control subsystem that monitors factors such as vehicle speed, ambient light, or motion to automatically (i.e., autonomously) restrict, change, or modify illumination functions.

In one embodiment, the processor module is further in communication with the artificial-intelligence (AI) engine configured to analyze gesture input history, ambient light levels, vehicular motion data, and user-defined presets, and wherein the AI engine automatically (i.e., autonomously) adjusts at least one of illumination intensity, color transitions, graphical display selection, or tint opacity of the glass assembly based on the analysis.

In another embodiment, the invention provides a method for controlling illumination and display output of a vehicular window. The method involves receiving wireless control commands at a processor module from a remote device and generating corresponding illumination control signals. The system activates fiber optic illumination strands embedded within a multi-layer electroplated glass assembly to produce a visual output such as colors, gradients, patterns, images, or dynamic designs. The system also receives touch input from a multilayer capacitive mesh on the glass and adjusts illumination characteristics such as tint opacity or display content in response. A safety control subsystem detects operational conditions of the vehicle, including speed, ambient light, or motion, and automatically (i.e., autonomously) overrides or modifies illumination modes when predetermined thresholds are met.

In a further embodiment, a multi-layer smart glass assembly designed for use with a vehicular illumination and display system is disclosed. The smart glass assembly includes a polycarbonate outer layer that offers impact-resistant transparency, an electroplated conductive layer that supports tint modulation and illumination control, and an interior structural substrate that provides rigidity. A multilayer capacitive mesh are embedded within one or more layers to capture touch gestures such as taps, swipes, and multi-touch inputs. The assembly further incorporates a plurality of fiber optic illumination strands arranged within or between layers to emit light across the surface. When the assembly receives illumination control signals from an external processor module, the assembly displays user-selected visual effects including colors, gradients, patterns, images, or animated graphical sequences.

In still another embodiment, a non-transitory computer-readable medium storing instructions that control the functionality of a smart vehicular window system is disclosed. When executed by a processor module, the instructions cause the processor to receive wireless commands specifying illumination characteristics such as tint level, color, pattern, or graphical display content. The processor interprets the commands and generates illumination driver signals that activate fiber optic illumination strands embedded in a multi-layer glass assembly. The instructions also enable the processor to interpret touch inputs from a capacitive mesh integrated into the glass assembly and adjust illumination settings accordingly. Additionally, the processor analyzes data from sensors of a safety control subsystem and automatically (i.e., autonomously) suppresses or modifies illumination output when safety thresholds are met.

In some embodiments, the processor module is further configured to adjust illumination output based on historical user interaction patterns, including previously selected colors, tint levels, or display sequences, and wherein the artificial-intelligence-based control routines automatically (i.e., autonomously) generate recommended illumination settings based on the historical patterns.

In one embodiment, the plurality of fiber optic illumination strands comprise side-emitting fibers arranged in a horizontal or vertical matrix pattern configured to provide uniform illumination distribution across the lateral extent of the glass assembly.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a block diagram architecture view of smart illumination and display system of the present invention in accordance with the disclosed structure;

FIG. 2 illustrates a cross-sectional view of the multi-layer electroplated glass assembly forming part of the smart illumination and display system of the present invention in accordance with the disclosed structure;

FIG. 3 illustrates an illustrative operating environment of the smart illumination and display system of the present invention in accordance with the disclosed structure;

FIG. 4 illustrates an exemplary user interface displayed by the software application configured to control the system of the present invention in accordance with the disclosed structure; and

FIG. 5 illustrates an exemplary visual output produced by the smart illumination and display system installed on a vehicle in accordance with the disclosed structure.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for an improved vehicular window system that overcomes the limitations of traditional transparent or tinted windows. There is a long-felt need in the art for a window system that enables users to customize the visual appearance of their vehicle without compromising visibility or violating safety regulations. Additionally, there exists a need for a window system that enables drivers and passengers to selectively modify tint levels, colors, or design elements in real time, rather than relying on static tint films or aftermarket modifications. Moreover, there is a need for a system that transforms a conventional window into an interactive surface capable of displaying patterns, images, messages, or illumination effects while still maintaining road-safe transparency. Finally, there exists a need for a technology that integrates advanced smart functionality including wireless connectivity, touch responsiveness, and intelligent control directly into the structure of the vehicle window itself.

The present invention, in one exemplary embodiment, is a method for controlling illumination and display output of a vehicular window. The method involves receiving wireless control commands at a processor module from a remote device and generating corresponding illumination control signals. The system activates fiber optic illumination strands embedded within a multi-layer electroplated glass assembly to produce a visual output such as colors, gradients, patterns, images, or dynamic designs. The system also receives touch input from a multilayer capacitive mesh on the glass and adjusts illumination characteristics such as tint opacity or display content in response. A safety control subsystem detects operational conditions of the vehicle, including speed, ambient light, or motion, and automatically (i.e., autonomously) overrides or modifies illumination modes when predetermined thresholds are met.

Reference will now be made in detail to the present preferred embodiments of the invention, examples of which are illustrated in the accompanying drawings. Wherever possible, the same reference numerals are used in the drawings and the description to refer to the same or like parts.

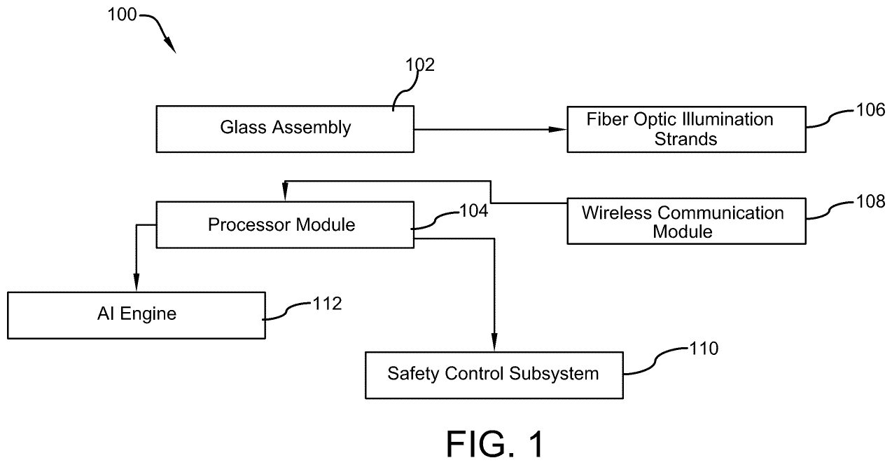

Referring initially to the drawings, FIG. 1 illustrates a block diagram architecture view of smart illumination and display system of the present invention in accordance with the disclosed structure. The smart illumination and display system 100 is configured for installation within, or integration into, the windows of a residential or commercial vehicle, and is designed to transform a traditionally static window surface into a fully interactive, illumination-capable, customizable digital display. In use, the system 100 enables a user to selectively modify window tint color, transparency level, and visual appearance, including the display of static or dynamic designs, images, graphical patterns, and multi-color illumination sequences. The system 100 further enables interaction with the window through touch-sensitive input gestures analogous to those used on modern smartphones or tablets. As described herein, the system 100 is adaptable to various window shapes, sizes, and vehicular applications.

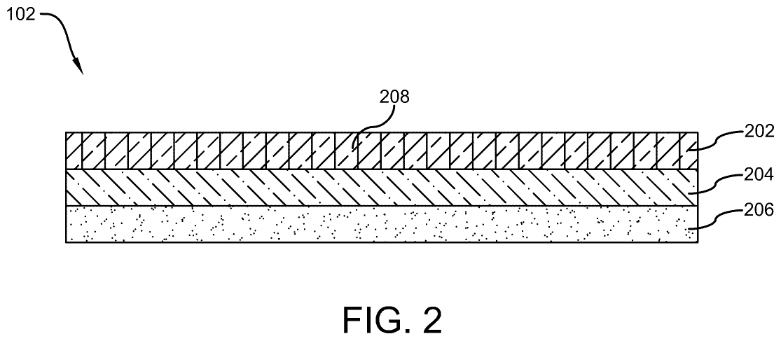

The smart illumination and display system 100 includes a multi-layer electroplated glass assembly 102 made from polycarbonate-based material layered with conductive electroplating (as described in FIG. 2). The glass assembly 102 can be formed from a polycarbonate-based transparent substrate or layer laminated with an electroplated conductive layer and one or more functional layers for illumination conduction, touch sensing, and display control. The polycarbonate substrate provides high impact resistance, reduced weight compared to traditional glass, and enhanced durability suitable for vehicular environmental (i.e., ambient) conditions.

The system 100 includes a processor module 104 which comprises a mobile-grade microprocessor. The processor module 104 is configured to execute illumination control instructions, process touch input signals, manage wireless communication, and operate artificial-intelligence-based control routines. The processor module 104 can be embedded within the window frame, disposed internally within the laminated glass structure, or mounted within a dedicated enclosure adjacent the glass assembly 102.

A plurality of fiber optic illumination strands 106 are embedded within, laminated between, or routed adjacent to layers of the glass assembly 102. The fiber optic illumination strands 106 can include side-emitting or end-emitting fibers configured to distribute light uniformly across the window surface. The fibers 106 are operatively coupled to one or more illumination drivers controlled by the processor module 104, enabling the production of gradient lighting effects, multi-color transitions, pattern-based illumination, or high-resolution visual output. External light sources such as LEDs may be positioned at one or both ends of the fiber optic illumination strands 106 to introduce illumination into the fiber network.

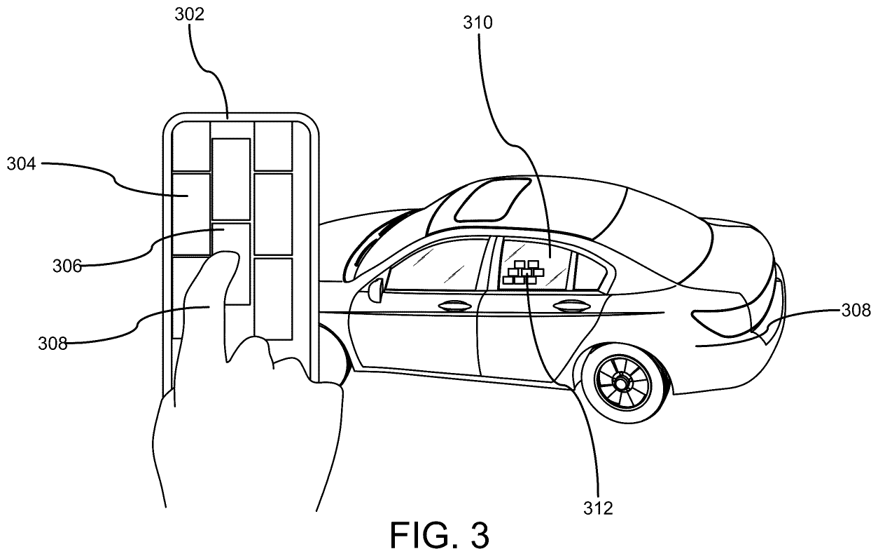

The system 100 further includes a wireless communication module 108 configured to receive user commands and configuration data from an external computing device such as a smartphone, tablet, or onboard vehicle infotainment system, as illustrated in FIG. 3. The wireless communication module 108 can transmit operational data, system status, gesture recognition events, or diagnostic information back to the external computing device. The wireless communication module 108 can support communication through a plurality of radiofrequency protocols including, but not limited to, Bluetooth, Wi-Fi, long-range cellular communication standards, vehicle-to-device protocols, or proprietary RF signaling. The wireless communication module 108 is electrically coupled to the processor module 104 such that received commands are translated into operational instructions for illumination control, tint or opacity modification, and display management.

A safety control subsystem 110 is configured to automatically (i.e., autonomously) restrict, change, or prevent illumination, opacity changes, or animated display functions when the vehicle in which the system 100 is installed, is in motion or when environmental, ambient, or visibility conditions require reduced distraction. The safety control subsystem 110 can include one or more sensors selected from speed sensors, accelerometers, ambient-light sensors, GPS-based motion detectors, or vehicle data interfaces such as the onboard diagnostic (OBD) system. The safety control subsystem 110 may automatically (i.e., autonomously) override or suppress illumination modes when the host vehicle exceeds a predetermined speed threshold or when environmental (i.e., ambient) conditions require full transparency of the window surface for compliance with visibility or roadway safety regulations.

In one embodiment, the processor module 104 can incorporate, or be in communication with, an artificial-intelligence (AI) engine module 112. The AI engine module 112 can be configured to perform real-time analysis of historical gesture input data, ambient light levels, vehicular motion data, and user-defined presets. Based on such analysis, the module 112 may automatically (i.e., autonomously) adjust illumination intensity, color transitions, design selection, or tint opacity of the glass assembly 102 without explicit user input. The AI engine module 112 may further perform predictive control operations, such as dimming illumination during nighttime driving, enhancing tint under strong sunlight conditions, or selecting low-distraction illumination modes when motion sensors detect acceleration or lane-change activity. The AI engine 112 and processor module 104 may communicate through a wired bus architecture, such as SPI, I2C, CAN bus, or a comparable embedded communication interface.

FIG. 2 illustrates a cross-sectional view of the multi-layer electroplated glass assembly forming part of the smart illumination and display system of the present invention in accordance with the disclosed structure. As illustrated, the glass assembly 102 includes a plurality of stacked layers that cooperate to provide impact-resistant transparency, touch-sensitivity, and conductive illumination functionality. The glass assembly 102 comprises a polycarbonate outer layer 202. The polycarbonate outer layer 202 extends across the entire lateral extent of the window assembly and provides a durable, optically clear, impact-resistant protective barrier suitable for vehicular environments. The polycarbonate material can be treated with anti-scratch coatings, UV-resistant coatings, or other surface treatments to improve long-term clarity and environmental durability.

An electroplated conductive layer 204 is positioned below the polycarbonate outer layer 202. The electroplated layer 204 can be formed from a conductive metallic or transparent conductive oxide material deposited or laminated onto the adjacent layers. The conductive layer 204 is configured to enable electronically controlled tint adjustment, selective illumination, and modulation of color or opacity across the glass assembly 102. In various embodiments, the electroplated layer 204 can support power distribution, pixel addressing, and illumination drive functions.

An interior structural substrate 206 is included in the assembly 102 and may consist of a polycarbonate, polymeric, glass-composite, or other structural material that provides rigidity and support for the layered assembly. The substrate 206 may further contribute to impact resistance, vibration damping, and structural reinforcement within the vehicle window frame.

As shown in FIG. 2, a multilayer capacitive mesh 208 are embedded within the polycarbonate outer layer 202. The capacitive mesh 208 comprises a grid, patterned film, or stacked electrode arrangement configured to detect touch inputs, gestures, or multi-touch events across the window surface. When connected to the processor module of the system, the capacitive mesh 208 enables the glass assembly 102 to function as a touch-sensitive interface similar to a smartphone or tablet display. The multilayer capacitive mesh 208 may be integrated into or along one or more layers of the assembly 102.

FIG. 3 illustrates an illustrative operating environment of the smart illumination and display system of the present invention in accordance with the disclosed structure. In the present embodiment, a user 308 interacts with a software application 304 installed on a smartphone 302 to select a desired illumination pattern or graphical display 306 for transmission to a vehicle 308. The application 304 presents a plurality of selectable graphical tiles or design options to enable the user 308 to select at least one design option 306.

The smartphone 302 is configured to communicate wirelessly with the smart illumination and display system installed in the vehicle 308. In the embodiment, the smartphone 302 transmits wireless control data, illumination commands, or display-selection information using one or more short-range or long-range wireless communication protocols, including but not limited to Bluetooth, Wi-Fi, cellular communication, or proprietary radio-frequency signaling. The wireless communication module 108 (FIG. 1) receives the commands and relays them to the processor 104 for execution.

As illustrated, the vehicle 308 includes one or more window glass assemblies 310, each of which can incorporate the multi-layer electroplated glass assembly previously described. In the example shown, the user-selected display here represented as a graphical message 312 is visibly illuminated on the side window of the vehicle. The illuminated design 312 is produced through the integrated fiber optic illumination network or conductive tint modulation components embedded within the window assembly. Upon receipt of the wireless transmission, the system processor 104 activates the appropriate illumination sequences to render the selected visual content on the window surface.

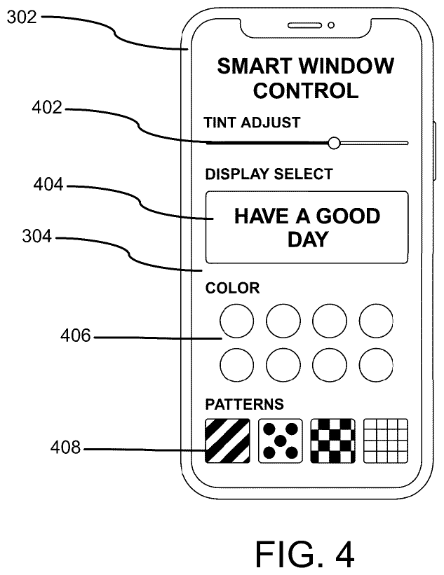

FIG. 4 illustrates an exemplary user interface displayed by the software application configured to control the system of the present invention in accordance with the disclosed structure. The application 304 provides a graphical user interface enabling the user to adjust illumination settings, tint levels, colors, and pattern selections for one or more vehicle window glass assemblies. As shown, the application 304 includes a tint adjustment control 402, which may be implemented as a horizontal slider configured to increase or decrease the transparency, opacity, or tint intensity of the glass assembly in real time.

The application interface further includes a display selection region 404. The display selection region 404 presents one or more user-selectable display messages, graphical prompts, or illumination presets. In the example illustrated, the user may select a preset display labeled “HAVE A GOOD DAY,” which, upon selection, is transmitted wirelessly to the vehicle for rendering on the smart window surface. In case the user does not want a display message, then, the display selection region 404 can be left blank.

The application 304 further includes a color selection interface 406 comprising a plurality of color-indicator icons. Each icon corresponds to a different selectable illumination color or color tone. The user may activate any of the color icons to adjust the illumination output of the fiber optic network or conductive display layers of the smart window system.

In addition, the application 304 includes a pattern selection interface 408. The pattern selection interface 408 displays a plurality of graphical pattern options, such as stripes, dots, checkered patterns, or grid-style textures. Selection of a pattern causes the associated display content to be transmitted wirelessly to the smart illumination and display system, enabling the vehicle windows to exhibit the chosen animated or static visual effect.

In operation, the remote device 302 communicates user commands generated by the application 304 to the smart illumination and display system using wireless communication protocols such as Bluetooth, Wi-Fi, cellular data, or proprietary RF communication. The processor module 104 of the system 100 receives and interprets the commands, triggers updates to the illumination, tint level, pattern selection, or display content on the multi-layer electroplated glass assemblies.

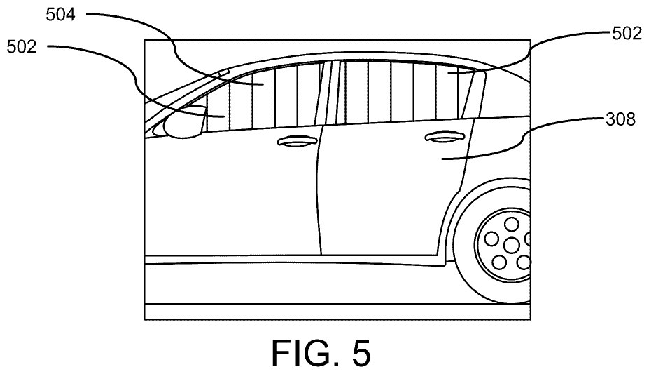

FIG. 5 illustrates an exemplary visual output produced by the smart illumination and display system installed on a vehicle in accordance with the disclosed structure. In the embodiment, the system 100 activates one or more glass assemblies 502 mounted in the side windows of the vehicle 308 to generate a full-surface, multi-color illumination effect. Each glass assembly 502 can correspond to the multi-layer electroplated glass assembly previously described, incorporating a conductive tint-modulation layer, fiber optic illumination strands, or alternative illumination structures capable of selectively emitting color gradients, patterns, or dynamic lighting sequences. As shown in FIG. 5, the illumination spans across the primary side window and rear quarter window region, forming a continuous or segmented color display depending on user selections or system settings.

The illustrated example depicts a color-gradient illumination output 504, in which the system generates a spectrum of colors transitioning smoothly across the surface of each glass assembly 502. The gradient may be produced through controlled activation of embedded fiber optic lighting elements within the glass assembly.

The illumination effect 504 may be initiated manually by the user through the remote device and application previously described, or automatically (i.e., autonomously) by the processor module in response to environmental (i.e., ambient) conditions, AI-based determinations, or preprogrammed display routines. The smart illumination and display system can support various display modes including static color fills, scrolling gradients, pulsed illumination, animated effects, or custom graphical displays.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “smart illumination and display system”, “multi-layer electroplated smart glass window assembly”, “multi-layer smart glass assembly system”, and “system” are interchangeable and refer to the smart illumination and display vehicular windows system 100 of the present invention.

Notwithstanding the forgoing, the smart illumination and display vehicular windows system 100 of the present invention can be of any suitable configuration as is known in the art without affecting the overall concept of the invention, provided that it accomplishes the above stated objectives. One of ordinary skill in the art will appreciate that the smart illumination and display vehicular windows system 100 shown in the FIGS. are for illustrative purposes only, and that many other configurations of the smart illumination and display vehicular windows system 100 are well within the scope of the present disclosure. Although the dimensions of the smart illumination and display vehicular windows system 100 are important design parameters for user convenience, the smart illumination and display vehicular windows system 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A window surface display control system comprising:
a multi-layer electroplated glass assembly;
a polycarbonate outer layer;
an electroplated conductive layer;
an interior structural substrate;
a processor module;
a plurality of fiber optic illumination strands; and
a wireless communication module;
wherein said polycarbonate outer layer laminated with said electroplated conductive layer;
wherein said electroplated conductive layer is positioned below said polycarbonate outer layer;
wherein said processor module comprises a mobile-grade microprocessor;
wherein said plurality of fiber optic illumination strands are embedded within said multi-layer electroplated glass assembly;
wherein said plurality of fiber optic illumination strands are operatively coupled to one or more illumination drivers controlled by said processor module for enabling effects to a window surface selected from the group consisting of production of gradient lighting effects, multi-color transitions, pattern-based illumination, graphical displays, and high-resolution visual output;
wherein said wireless communication module is configured to receive user commands from an external computing device; and
further wherein said external computing device selected from the group consisting of a smartphone, a tablet, and an onboard vehicle infotainment system.

2. The window surface display control system of claim 1, wherein said wireless communication module transmits operational data selected from the group consisting of system status, gesture recognition events, and diagnostic information back to said external computing device.

3. The window surface display control system of claim 2, wherein said wireless communication module is electrically coupled to said processor module for receiving said user commands and translating said user commands into operational instructions selected from the group consisting of illumination control, tint modification, and display management of the window surface.

4. The window surface display control system of claim 3 further comprising a safety control subsystem configured to autonomously modify said operational instructions in response to ambient conditions, wherein said safety control subsystem includes one or more sensors selected from the group consisting of speed sensors, accelerometers, ambient-light sensors, GPS-based motion detectors, and vehicle data interfaces.

5. The window surface display control system of claim 4, wherein said plurality of fiber optic illumination strands comprise a fiber network selected from the group consisting of side-emitting fibers and end-emitting fibers configured to distribute light uniformly across the window surface.

6. The window surface display control system of claim 4, wherein said safety control subsystem is configured to autonomously modify said operational instructions in response to a host vehicle exceeding a predetermined speed threshold.

7. The window surface display control system of claim 6, wherein said processor module is configured to execute functions selected from the group consisting of illumination control instructions, process touch input signals, manage wireless communication, and operate artificial-intelligence-based control routines.

8. The window surface display control system of claim 5 further comprising LED light sources positioned proximally to at least one end of said plurality of fiber optic illumination strands to introduce illumination into said fiber network.

9. A window surface display control system comprising:
a multi-layer electroplated glass assembly;
a polycarbonate outer layer;
an electroplated conductive layer;
an interior structural substrate;
a processor module;
a plurality of fiber optic illumination strands;
a wireless communication module; and
a capacitive mesh;
wherein said polycarbonate outer layer laminated with said electroplated conductive layer;
wherein said electroplated conductive layer is positioned below said polycarbonate outer layer;
wherein said plurality of fiber optic illumination strands are embedded within said multi-layer electroplated glass assembly;
wherein said plurality of fiber optic illumination strands are operatively coupled to one or more illumination drivers controlled by said processor module for enabling effects selected from the group consisting of production of gradient lighting effects, multi-color transitions, pattern-based illumination, graphical displays, and high-resolution visual output;
wherein said wireless communication module is configured to receive user commands from an external computing device;
wherein said external computing device selected from the group consisting of a smartphone, a tablet, and an onboard vehicle infotainment system; and
further wherein said capacitive mesh is embedded within said polycarbonate outer layer to detect touch inputs across the window surface.

10. The window surface display control system of claim 9, wherein said capacitive mesh comprises an arrangement selected from the group consisting of a grid, a patterned film, and a stacked electrode arrangement configured to detect said touch inputs.

11. The window surface display control system of claim 9, wherein said wireless communication module transmits operational data selected from the group consisting of system status, gesture recognition events, and diagnostic information back to said external computing device.

12. The window surface display control system of claim 9, wherein said wireless communication module is electrically coupled to said processor module for receiving said user commands and translating said user commands into operational instructions selected from the group consisting of illumination control, tint modification, and display management.

13. The window surface display control system of claim 12 further comprising a safety control subsystem is configured to autonomously modify said operational instructions in response to ambient conditions, wherein said safety control subsystem includes one or more sensors selected from the group consisting of speed sensors, accelerometers, ambient-light sensors, GPS-based motion detectors, and vehicle data interfaces.

14. The window surface display control system of claim 13, wherein said safety control subsystem is configured to autonomously modify said operational instructions in response to a host vehicle exceeding a predetermined speed threshold.

15. The window surface display control system of claim 9, wherein said processor module is configured to execute functions selected from the group consisting of illumination control instructions, process touch input signals, manage wireless communication, and operate artificial-intelligence-based control routines.

16. A vehicle window surface display control system comprising:
a multi-layer electroplated glass assembly;
a polycarbonate outer layer;
an electroplated conductive layer;
an interior structural substrate;
a processor module;
a plurality of fiber optic illumination strands;
a wireless communication module; and
a software application;
wherein said polycarbonate outer layer laminated with said electroplated conductive layer;
wherein said electroplated conductive layer is positioned below said polycarbonate outer layer;
wherein said plurality of fiber optic illumination strands are embedded within said multi-layer electroplated glass assembly;
wherein said plurality of fiber optic illumination strands are operatively coupled to one or more illumination drivers controlled by said processor module for enabling effects to a vehicle window surface selected from the group consisting of production of gradient lighting effects, multi-color transitions, pattern-based illumination, graphical displays, and high-resolution visual output;
wherein said wireless communication module is configured to receive user commands from an external computing device;
wherein said external computing device selected from the group consisting of a smartphone, a tablet, and an onboard vehicle infotainment system; and
further wherein said software application communicates said user commands to said processor module for enabling said effects to the vehicle window surface.

17. The vehicle window surface display control system of claim 16, wherein said wireless communication module transmits operational data selected from the group consisting of system status, gesture recognition events, and diagnostic information back to said external computing device.

18. The vehicle window surface display control system of claim 16, wherein said wireless communication module is electrically coupled to said processor module for receiving said user commands and translating said user commands into operational instructions selected from the group consisting of illumination control, tint modification, and display management of the vehicle window surface.

19. The vehicle window surface display control system of claim 18 further comprising a safety control subsystem configured to autonomously modify said operational instructions in response to ambient conditions, wherein said safety control subsystem includes one or more sensors selected from the group consisting of speed sensors, accelerometers, ambient-light sensors, GPS-based motion detectors, and vehicle data interfaces.

20. The vehicle window surface display control system of claim 19, wherein said safety control subsystem is configured to autonomously modify said operational instructions in response to a host vehicle exceeding a predetermined speed threshold.
